(19) United States
(12) Patent Application Publication
(10) Pub. No.: US 2026/0134219 A1
(43) Pub. Date: May 14, 2026

(54) REDUCING HALLUCINATIONS BY TRACKING INFORMATION FLOW IN A CONVERSATION

(71) Applicant: GOOGLE LLC, Mountain View, CA (US)

(72) Inventor: Keun Soo Yim, San Jose, CA (US)

(21) Appl. No.: 18/943,592

(22) Filed: Nov. 11, 2024

(51) Int. Cl. G06F 40/35; G06F 40/279

(52) U.S. Cl. CPC G06F 40/35; G06F 40/279

(57) ABSTRACT

Disclosed implementations for reducing hallucinations in a generative model by tracking information flow in a dialogue provided by a source during a conversation. Conversation data regarding a conversation among a plurality of sources is received via a user interface. The conversation data is processed through a generative model to associate an intent to each source of the plurality of sources. A summary for the conversation based on a preferred source of the plurality of sources and the intents associated with each source of the plurality of sources is provided via the user interface.

### BACKGROUND

Generative models (e.g., large language models (LLMs)) are machine-learning models trained to generate a response (estimate the probability of a sequence of tokens, including words and/or emoji) in response to a prompt. Such language models have a high number of parameters (e.g., billions, hundreds of billions) and are commonly based on a transformer architecture. These models can generate realistic text or image responses to a prompt and can generate entirely new content, referred to as creative content.

### SUMMARY

Implementations described herein relate to systems and methods for determining a summary of a conversation by tracking the flow of information in dialogue provided by each participant (e.g., each source) in the conversation. In particular, a generative model is trained to determine an intent for each source by capturing patterns, tracking information flow, and generating summaries from conversation data. In an example implementation, conversation data regarding a conversation among a plurality of sources is received via a user interface. The conversation data is processed through a generative model to associate an intent to each source of the plurality of sources. A summary for the conversation based on a preferred (e.g., based on a user provided selection) source of the plurality of sources and the intents associated with each source of the plurality of sources is provided via the user interface.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

FIG. 1 depicts an example architecture that can be employed to execute implementations of the present disclosure.

FIG. 2 depicts an example generative system, according to disclosed implementations.

FIG. 3 depicts a flowchart of a non-limiting process for determining a summary of a conversation that can be performed by implementations of the present disclosure.

FIG. 4 depicts an example of a distributed computer device that can be used to implement the described techniques.

### DETAILED DESCRIPTION

A technical problem with generative models (e.g., generative artificial intelligence (GenAI) and language models) is that their generated content can include inaccurate information because these models can generate content freely. The inaccurate generated content is referred to as a hallucination. Hallucinations are typically classified as intrinsic (inaccuracies compared with the provided input or context) and extrinsic (inaccuracies compared with externally known facts). Detecting and/or reducing hallucinations is an important technical problem affecting the usefulness of generative models.

Accordingly, implementations described herein provide at least one technical solution to these technical problems by assigning an intent to sources of information in a conversation to reduce the hallucination of the model. Generally, the intent of a source of information (e.g., a speaker in a conversation) is the purpose and/or reason behind the information that is provided. Unlike conventional generative models that use declarative statements or add conditions to the question (query), generative models trained and employed within the described system use statements that are conditional to the context of the conversation or specific dialogue within a conversation that is being summarized. Furthermore, the system trains a generative model to track the flow of information in each dialogue within a conversation to determine a context and generate responses based on these contexts as well as the information provided expressed in each dialogue. Implementations may also be used to improve the quality of responses provided by the generative model. For example, implementations may support an improved personal assistant that better understands a user's preferences, with user permission, based on a user's intent. Implementations can also provide a benchmark for building generative models. Thus, the user experience can be improved because information (e.g., query results, attribution of conversations and the specific dialogues within, and the like) provided by generative models will better match the user's informational needs and thereby reduce the hallucinations of the model and in particular, hallucinations as perceived by the user.

In some implementations, the described system employs a generative model to process conversation data that includes dialogue from each of a number of sources. The generative model may be employed to summarize a conversation by focusing on the dialogue provided by a particular source or group of sources instead of a typical abstractive text summarization where the utterances of all sources are summarized. Summarization of the utterances of all sources can introduce intrinsic hallucinations because an initial intent of a speaker may be lost or obscured as the conversation progresses. In some cases, the generative model is trained to determine an intent of a source based on both the explicit words expressed in the dialogue provided by the source as well as the implicit intent of, or premise behind, these words. In such examples, the system trains the underlying generative model with a deep understanding of conversational contexts and flows. This deep understanding enables disclosed implementations to extract the intent of each speaker.

As used herein, a conversation is made up of participants (i.e., sources) taking turns communicating. A dialogue is a portion of a conversation that represents a turn taken (utterance) by a source. Put another way, a dialogue represents a certain source's side (turns or portions) of a conversion. A source of dialogue may include a human speaker or an artificial intelligence (AI) source, such as a chatbot. In some implementations, the generative model is trained to attribute each dialogue in the conversation data to a respective source and determine an intent of the source of each dialogue in the conversation. An intent may reflect, for example, a purpose, an overarching concept(s), a goal(s) and/or a motivation behind what is being said by the source. In some cases, both the explicit words captured in a dialogue as well as the implicit premise behind these words are processed by the generative model to determine what information is provided by the particular source.

In some cases, a dialogue from a conversation may be attributed to more than one source such as a group of people functioning in the conversation as a single entity. For example, words spoken by individuals on a committee or board during a conversation may be grouped together and processed as a single dialogue by the generative model because determining the intent of this group as a whole is informative to the query provided by the user. In such an example, a query may include “provide a summary of the public committee meeting from the perspective of the committee.” In some cases, a conversation may only include dialogue from a single source (i.e., a monologue). In such cases, the generative model may be trained to provide a summary from the single source's perspective or from the perspective of someone outside the conversation. For example, “provide a summary of Vivian Bearing's opening monologue in the play Wit by playwright Margaret Edson from Vivian's perspective” or alternative “from the perspective of the audience.” However, the description below describes attributing a dialogue to one particular source for simplicity.

Once the dialogues and intent behind them have been determined and attributed to a source, the model may be employed to provide responses to queries about the conversation. To reduce intrinsic hallucination of the generative model, in some cases, a weight value(s) is applied to each source based on the end user's preferences. In some implementations, each source (or a group of sources) is weighted using a weight function(s). In some cases, the generative model is trained based on these user preferences. For example, the user may indicate that he or she favors/values information from a particular source(s) in conversation. In some cases, responses to queries regarding the conversation are selected based on these user preferences. When the user provides the system with a query related to the conversation (e.g., “what is the primary purpose of the conversation”), the system may select a response for the query based on these preferences (e.g., the system may select a response that is weighted more heavily to favor the intent of the preferred source).

### Example Environment

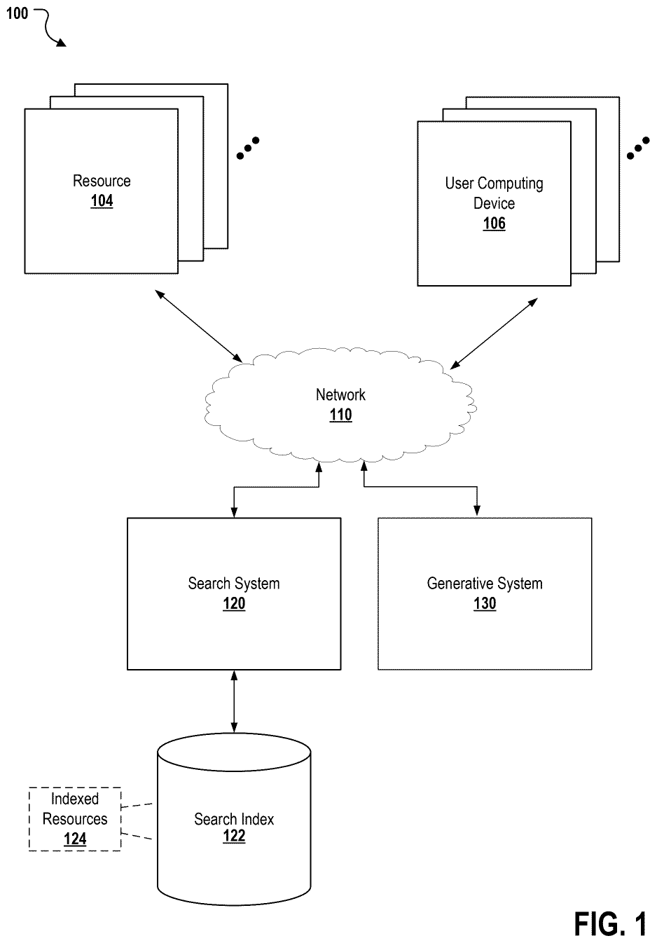

FIG. 1 is a block diagram of an example architecture in which users can interact with one or more generative models trained to summarize a conversation between/among two or more sources (e.g., a speaker or an AI source) and/or provide an attribution process for dialogue data. As depicted, a communications network 110 connects user computing devices 106 with a search system 120, a generative system 130, and resources 104.

The communications network 110 may include wireless and wired portions that may be accessed over a wired and/or a wireless communications link. For example, user computing devices 106, such as smartphones can use a cellular network to access the communications network 110. The environment 100 may include millions of resources 104 (e.g., provided via web site) and user computing devices 106. In some cases, the communications network 110 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a telephone network. The communications network 110 may also include future developed networks. In some implementations, the communications network 110 includes the Internet, an intranet, an extranet, or an intranet and/or extranet that is in communication with the Internet. In some implementations, the communications network 110 includes a telecommunication or a data network.

As used herein, resources 104 can refer to any content accessible by an identifier by a search engine or content, such as a dialog, provided by the user computing device 106 (e.g., in addition to the query). Thus, resources 104 may include web resources, documents, media (e.g., multimedia content), programming elements, and the like. Other example web resources include, but are not limited to, text, images files, video files, audio files, feed sources, and the like.

A web resource (e.g., a web page) includes data that can be provided over the communications network 110 via a resource address (e.g., a uniform resource locator (URL)). In some cases, the web resources 104 are formatted in a markup language (e.g., hypertext markup language (HTML), extensible markup language (XML), and the like). In some cases, the resources 104 (e.g., web resources) include embedded information such as metadata information, hyperlinks, embedded instructions (e.g., scripts) and the like. In some cases, the resources 104 are published by a resource provider via a website. Such a website may include a collection of the resources 104.

In some cases, the search system 120 and the generative system 130 as well as publishers of some of the resources 104 are associated with a domain(s) and hosted by one or more servers in one or more locations. In some cases, these one or more servers include a server-class hardware type device and/or computer systems using clustered computers and components to function as a single pool of seamless resources when accessed through the communications network 110. For example, such implementations may be used in data center, cloud computing, storage area network (SAN), and network attached storage (NAS) applications. In some implementations, the one or more servers are deployed using a virtual machine(s).

In some implementations, user computing device(s) 106 is an electronic device capable of requesting and receiving resources over the communications network 110. Example user computing devices 106 include personal computers, mobile communication devices, tablet computers, Extended Reality (XR) devices, smart wearable devices (watches, rings, glasses), smart televisions, and the like. The user computing devices 106 may include (e.g., may each include) any appropriate type of computing device, such as a desktop computer, a laptop computer, a handheld computer, a tablet computer, a personal digital assistant (PDA), an augmented reality (AR)/virtual reality (VR) device, a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some implementations, the search system 120 accesses a search index 122 to search resources 104. In some implementations, the search index 122 includes a datastore of resources 104 (indexed resources 124) generated by crawling the information (e.g., web sites) provided by the publisher of the resource 104. In some implementations, the search index 122 is a repository for persistently storing and managing collections of data. Example data stores, such as the search index 122, that may be employed within the described system include data repositories, such as a database as well as simpler store types, such as files, emails, and so forth. In some implementations, the search index 122 includes a database. In some implementations, a database is a series of bytes or an organized collection of data that is managed by a database management system (DBMS).

In some implementations, the user computing devices 106 are configured to submit search queries to the search system 120 (e.g., via a web service provided by the search system 120). In some implementations, in response to each query, the search system 120 is configured to identify resources that are relevant to the query from the information stored in the search index 122. For example, the search system 120 may, for example, identify the resources 104 in the form of search results. Once generated, the search results are provided as part of a search result page to the user computing device 106 from which the query was received.

In some examples, a user computing device 106 can include one or more input modalities. Example input modalities can include a keyboard, a touchscreen, a mouse, a stylus, and/or a microphone. For example, a user can use a keyboard and/or touchscreen to type in a search query. As another example, a user can speak a search query, the user speech being captured through the microphone, and processed through speech recognition to provide the search query.

In response to receiving a search query, the search system 120 processes the query and accesses the search index 122 to identify resources 104 that are relevant to the search query (e.g., have at least a minimum specified relevance score for the search query). The search system 120 identifies the resources 104, generates a search result page. a search result page is generated by the search system 120 in response to a query. The search result page includes search results and can include other content, such as ads, knowledge panels, short answers, other types of rich results, links to limit the search to a particular resource type (e.g., images, travel, shopping, news, videos, etc.), other suggested searches, and the like. The resources were determined to be responsive to the query by the search engine. The search result includes a link to a corresponding resource. Put another way, each search result represents/is associated with a resource. The search result can include additional information, such as a title, a portion of text obtained from the content of the resource (e.g., a snippet), an image associated with the resource, etc., or other information relevant to the resource and/or the query, as determined by the search engine of the search system 120.

In some implementations, the generative system 130 trains and uses a generative model to provide responses to queries provided by the user computing devices 106. In some implementations, the generative system 130 may be co-located with the search system 120. In other words, in some implementations the generative system 130 and the search system 120 may be operated at the same server, which may be a distributed server. In some cases, the generative system 130 is supported by the search system 120; however, implementations are not limited to Internet search engines and can be supported by other types of search engines that are configured to provide resources responsive to a query.

In disclosed implementations, the generative system 130 may also send a query to the search system 120. The generative system 130 may use an application programming interface (API) of the search engine of the search system 120. The search engine API may return search results in a way that is not formatted for display, but instead enables the generative system 130 to read, analyze, and further process the information in a search result (e.g., the resource address, the relevant text extracted from the content, the title, etc.). In addition, the search engine API may enable the generative system 130 to request properties of the returned search results.

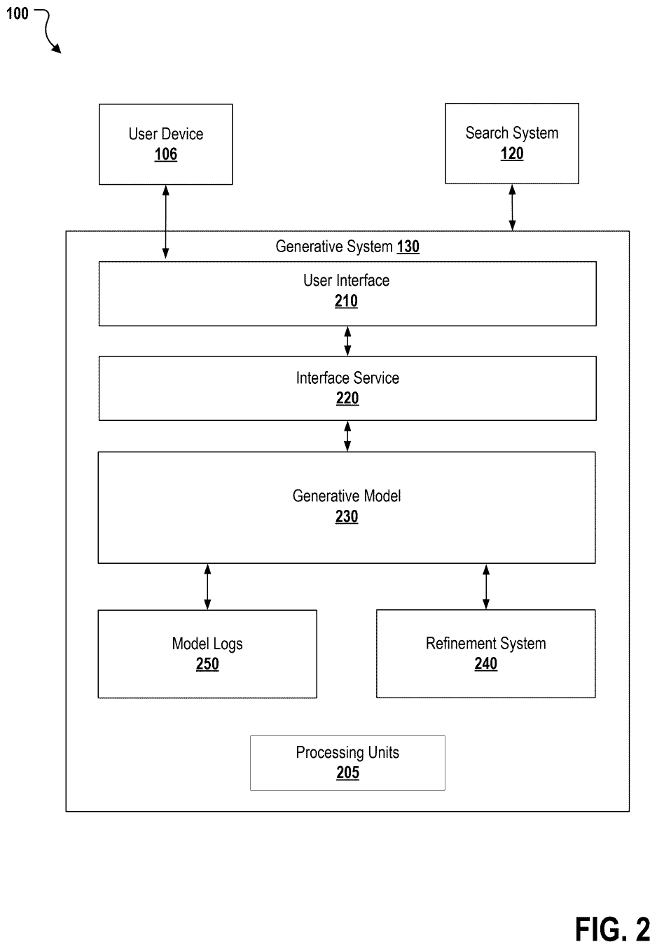

In accordance with implementations of the present disclosure, the example environment 100 also includes generative system 130 communicably coupled to the search system 120 (e.g., directly coupled or coupled over a network such as communications network 110). The generative system 130 may also be communicably coupled to a web site that provides one or more of the resources 104 and/or one or more of the user computing devices 106. In some implementations, the generative system 130 includes a generative model and is described in more detail with respect to FIG. 2.

FIG. 2 is a diagram that illustrates an example of the generative system 130, according to disclosed implementations. As described above, the generative system 130 may be configured to generate a summary of a conversation among sources each providing a dialogue. A prompt can be any input received from the user device 106 (e.g., via user interface 210). In some examples, a prompt may include data (e.g., dialogue data) and a query related to the data. In some examples, a prompt may include a query and a preferred source(s). One or more of the components of the generative system 130 can be, or can include processors (e.g., processing units 205) configured to process instructions stored in a memory. Examples of such instructions as depicted in FIG. 2 include the user interface 210, interface service 220, generative model 230, refinement system 240, and model logs 250.

The user interface 210 is configured to receive prompts from the user device 106. In some implementations, user interface 210 receives the prompts over a network interface (e.g., over a network such as the communications network 110). The user interface 210 can be configured to display a prompt input area. The prompt input area may take text as input. The prompt input area may take media (audio/video) files as input (e.g., of a conversation between/among sources). The user interface 210 may also be configured to display a response to the provided prompt. In some implementations, the user interface 210 may be part of (included in) another user interface. For example, the user interface 210 can be part of a search engine user interface, a browser tool or extension, a document extension or add in, and the like.

The user interface 210 may be configured to display a session. The user interface 210 may be configured to display a portion of a session. In some cases, a session includes prompts and responses (prompt rounds) and can be defined by a user. For example, the user interface 210 may include a control that enables the user to expressly start a new session. A session can be defined by a predetermined number of prompt rounds (a round being a prompt and its corresponding response). In such an implementation, a new session may begin after the predetermined number of prompt rounds. A session can be defined by a tab or window. For example, a session may encompass all prompt rounds occurring within the browser tab or window in which the user interface 210 is presented. In some implementations, the generative system 130 can expressly end a session based on some criteria (e.g., based on a topic or other characteristic of a prompt, number of prompt rounds, and so forth). An indication of the new session may be included in a final response for an ending session. A session is part of a prompt context. A prompt context can thus include a current prompt and the prior prompt rounds. If no prior prompt rounds exist, the prompt context may include the current prompt. In some implementations, the prompt context can include metadata (e.g.,). The metadata can include a number of prior prompt rounds. The metadata can include, with user permission, information related to a conversation provided by the user, information about content displayed on a display of the user device 106, a topic and/or entity determined from the content displayed on the display, information about the user device 106 and/or user preferences (with user permission) relevant to the prompt, and the like.

The user interface 210 may be configured to receive a prompt that includes a query, a media file of a conversation, and user preference related to the conversation and/or query from the user device 106. In some implementations, the information from the user interface 210 is provided to the generative model 230 via the interface service 220. In some implementations, the generative model 230 is trained to attribute dialogues for the various sources in the conversation data as well as an intent of the particular source of each dialogue. For example, in some implementations, both the explicit words in each dialogue as well as the implicit premise behind these words are processed by the generative model 230 to determine what information is provided by each source of dialogue in the conversation.

In some implementations, the generative model 230 is trained to determine possible answers to the provided query by capturing patterns in a dialogue (as well as in the conversation as a whole) and tracking the flow of information during a conversation. In some implementations, the generative model 230 is trained to summarize a dialogue with a provided conversation by focusing on the utterances of one particular speaker or group of speakers instead of a typical abstractive text summarization where the utterances of all speakers are summarized. In such examples, the generative model 230 is trained with a deep understanding of conversational contexts and flows (e.g., to extract the intent of each speaker). For example, the generative model 230 may process the conversation data and determine an intent for each source (e.g., speaker).

For example, a trust level may be set for each source based on the preference provided via the prompt (e.g., the user's preferred speaker and/or preferred source in the conversation). The generative model 230 may be trained to employ weighted values to reflect that trust level associated with each source. In some cases, the generative model 230 is trained to then track the semantic meaning of each dialogue and relabel the speaker for each intent and provide a weighted value for each speaker in the context of each intent. In some cases, a weighted sum for each source is determined and compared to a threshold to determine, for example, whether to use an intent associated with a source for a subsequent process.

In some cases, the generative model 230 is trained to provide a summarization of the conversation based on the attribution of the weighted values applied to each respective source providing a dialogue in the conversion data to reduce extrinsic hallucinations. The user provided preferences allows for the hallucination detection at a local level (e.g., the output provided to a specific user). In some implementations, the generative model 230 is trained to weight the sources to reflect the trust level as set by the user using a weight function(s).

As depicted in FIG. 2, the interface service 220 provides a layer between the user interface 210 and the generative model 230. For example, a user may provide a conversation from a conference with multiple speakers. The user may also set a preference for one or more of the speakers. The user may then provide a query to the generative model 230, via the interface service 220, to determine the overall summary or premise of the conversation. In some cases, interface service 220 processes the output provided by the generative model 230 and returns the summary that relies most heavily on, for example, the context/information provided by the preferred speakers (e.g., as determined by a threshold function).

In some cases, the interface service 220 reconfigures the generative model 230 based on the preferences provided by the user (e.g., the preferred sources of information in the conversation). For example, the interface service 220 retrain the generative model 230 based on the preferred sources or configure/retrain a layer of the generative model 230. In some cases, the interface service 220 may configure the generative model 230 via Low-Rank Adaptation (LoRA) by applying new weights to the generative model 230 based on the conversation data and the preferred sources of information.

In some implementations, the generative system 130 may generate model logs 250. Model logs 250 includes log records that capture a session. A session record includes at least a prompt and the generated response. Some session records in the model logs 250 may also capture the provided conversation and/or a summary of the conversation. The model logs 250 may be used by the refinement system 240 to generate training data used by the generative system 130 to further refine (fine-tune, train) the generative model 230. The refinement system 240 is configured to generate training data used to further train (refine) the generative model 230. The training data can include labeled training examples to assist with various training techniques, such as few-shot training.

### Example Process

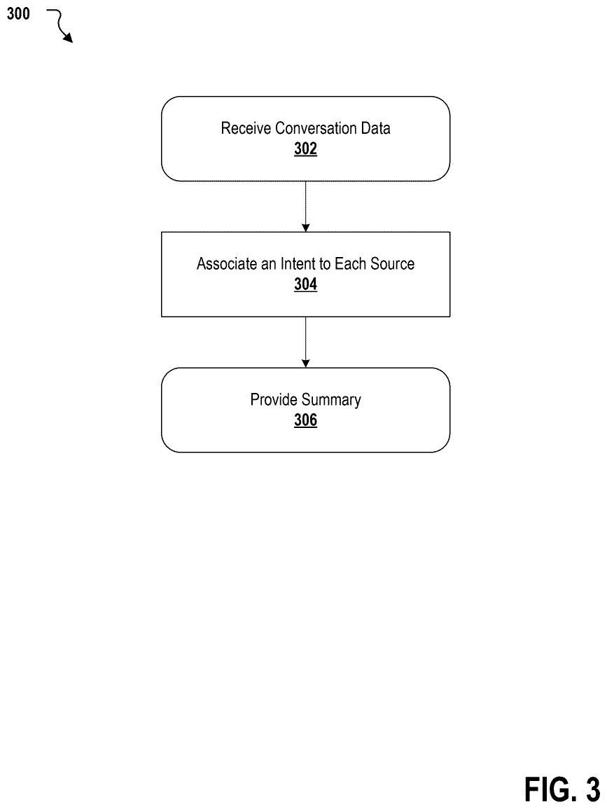

FIG. 3 depicts a flowchart of an example process 300 respectively that can be implemented by implementations of the present disclosure. The example process 300 can be implemented by systems and components described with reference to FIGS. 1 and 2. The example process 300 shows in more detail how a summary of a conversation is determined using a trained generative model (e.g., the generative model 230) based on the conversation data and a preferred source (or sources), such as a particular speaker participating in the conversation.

For clarity of presentation, the description that follows generally describes the example process 300 in the context of FIGS. 1 and 2. However, it will be understood that the process 300 may be performed, for example, by any other suitable system, environment, software, and hardware, or a combination of systems, environments, software, and hardware as appropriate. In some implementations, various operations of the process 300 can be run in parallel, in combination, in loops, or in any order.

At 302, the user interface 210 receives conversation data regarding a conversation among a plurality of sources from the user device 106. In some cases, the user interface 210 receives a prompt from the user device 106 that includes the conversation data. In some cases, the user interface 210 receives the preferred source from the user device 106 with the conversation data (e.g., the preferred source is included in the prompt). In some cases, the conversation includes a plurality of dialogues. In some cases, each dialogue of the plurality of dialogues is associated with a source of the plurality of sources. In some cases, the plurality of sources include a human speaker or information provided via artificial intelligence.

From 302, the process 300 proceeds to 304 where the generative model 230 processes the conversation data to associate an intent to each source of the plurality of sources. In some cases, the interface service 220 trains (or retrains) the generative model 230 based on the conversation data and the preferred source. In some cases, the interface service 220 configures the generative model via Low-Rank Adaptation based on the conversation data and the preferred source.

In some cases, the generative model 230 associates the intent to each source of the plurality of sources by determining explicit words in a dialogue provided by the source; determining an implicit premise of the source during the dialogue; and determining the intent for the source based on the explicit words and the implicit premise. In some cases, the generative model 230 determines the implicit premise for the source includes classifying the implicit premise by determining a dialogue pattern and tracking a flow of information during the dialogue. In some cases, the generative model 230 is configured to understand conversational contexts and flows information to determine the intent of each source of the plurality of sources.

From 304, the process 300 proceeds to 306, where the user interface 210 provides a summary for the conversation based on a preferred source of the plurality of sources and the intents associated with each source of the plurality of sources to the user device 106. In some cases, the user interface 210 provides the intent of the preferred source to the user device 106.

In some cases, the generative model 230 is configured to generate the summary for the conversation based on a weighted value associated with each source of the plurality of sources. In some cases, the weighted values reflect that trust level associated with each source of the plurality of sources. In some cases, the generative model 230 is configured to generate the summary for the conversation based on a weighted sum of the weighted values and a threshold value associated with the preferred source. In some cases, the generative model 230 is configured to track a semantic meaning of each dialogue of the plurality of dialogues and relabel the source according to each respective intent. From 306, the process 300 ends or repeats.

### Example System

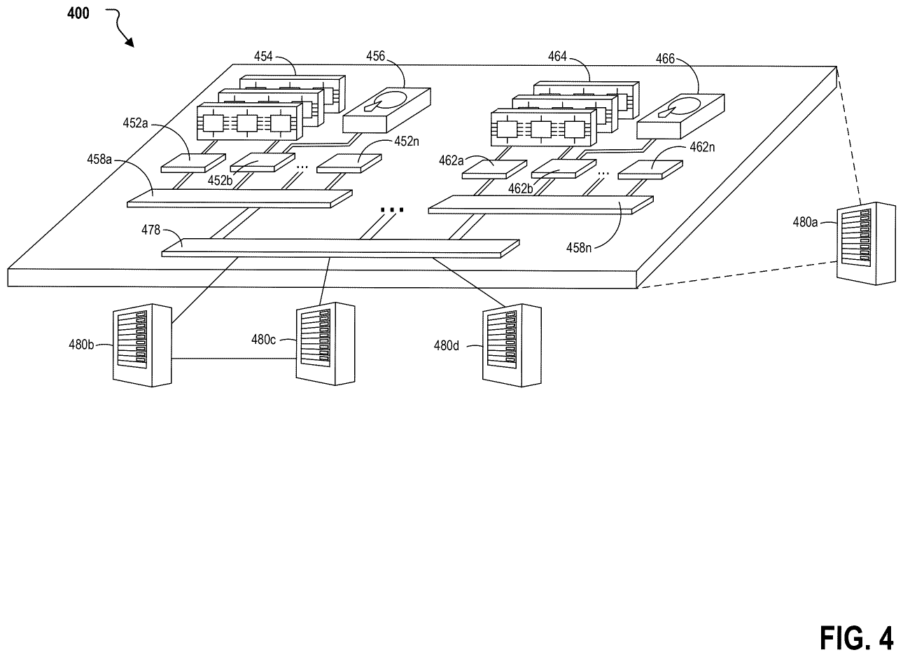

FIG. 4 shows an example of a computing device 400, which may be generative system 130 of FIGS. 1 and 2, which may be used with the techniques described here. The example computing device 400 can be programmed or otherwise configured to implement systems or methods of the present disclosure. Computing device 400 is intended to represent various example forms of large-scale data processing devices, such as servers, blade servers, data centers, mainframes, and other large-scale computing devices. Computing device 400 may be a distributed system having multiple processors, possibly including network attached storage nodes, that are interconnected by one or more communication networks. The components shown here, their connections and relationships, and their functions, are meant to be examples only, and are not meant to limit implementations of the implementations described and/or claimed in this document.

Computing device 400 may be a distributed system that includes any number of computing devices 480 (e.g., 480a, 480b, . . .480n). Computing devices 480 may include a server or rack servers, mainframes, and the like. communicating over a local or wide-area network, dedicated optical links, modems, bridges, routers, switches, wired or wireless networks, etc.

In some implementations, each computing device may include multiple racks. For example, computing device 480 a includes multiple racks (e.g., 458a, 458b, . . . , 458n). Each rack may include one or more processors, such as processors 452a, 452b, . . . , 452n and 462a, 462b, ..., 462n. The processors may include data processors, network attached storage devices, and other computer-controlled devices. In some implementations, one processor may operate as a master processor and control the scheduling and data distribution tasks. Processors may be interconnected through one or more rack switches 462a-462n, and one or more racks may be connected through switch 478. Switch 478 may handle communications between multiple connected computing devices 400.

Each rack may include memory, such as memory 454 and memory 464, and storage, such as 456 and 466. Storage 456 and 466 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 456 or 466 may be shared between multiple processors, multiple racks, or multiple computing devices and may include a non-transitory computer-readable medium storing instructions executable by one or more of the processors. Memory 454 and 464 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 454 may also be shared between processors 452a-452n. Data structures, such as an index, may be stored, for example, across storage 456 and memory 454. Computing device 400 may include other components not shown, such as controllers, buses, input/output devices, communications modules, and the like.

An entire system may be made up of multiple computing devices 400 communicating with each other. For example, device 480a may communicate with devices 480b, 480c, and 480d, and these may collectively be known as search system 120. Some of the computing devices may be located geographically close to each other, and others may be located geographically distant. The layout of computing device 400 is an example only and the system may take on other layouts or configurations.

It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Moreover, various implementations of the systems and techniques described herein can be realized in digital electronic circuitry, integrated circuitry, specially designed ASICs (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural or object-oriented programming language, or in assembly/machine language. As used herein, the terms “machine-readable medium” and “computer-readable medium” refers to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

What is claimed is:

1. A method comprising:
receiving, via a user interface, conversation data regarding a conversation among a plurality of sources;
processing the conversation data through a generative model to associate an intent to each source of the plurality of sources, and
providing, via the user interface, a summary for the conversation based on a preferred source of the plurality of sources and the intents associated with each source of the plurality of sources.

2. The method of claim 1, wherein the generative model is configured to generate the summary for the conversation based on a weighted value associated with each source of the plurality of sources.

3. The method of claim 2, wherein the weighted values reflect that trust level associated with each source of the plurality of sources.

4. The method of claim 3, wherein the generative model is configured to generate the summary for the conversation based on a weighted sum of the weighted values and a threshold value associated with the preferred source.

5. The method of claim 2, wherein the conversation includes a plurality of dialogues, and wherein each dialogue of the plurality of dialogues is associated with a source of the plurality of sources.

6. The method of claim 5, wherein the generative model is configured to track a semantic meaning of each dialogue of the plurality of dialogues and relabel the source according to each respective intent.

7. The method of claim 1, further comprising:
training the generative model based on the conversation data and the preferred source.

8. The method of claim 1, further comprising:
configuring the generative model via Low-Rank Adaptation based on the conversation data and the preferred source.

9. The method of claim 1, wherein the generative model associates the intent to each source of the plurality of sources by:
determining explicit words in a dialogue provided by the source;
determining an implicit premise of the source during the dialogue; and
determining the intent for the source based on the explicit words and the implicit premise.

10. The method of claim 9, wherein determining the implicit premise for the source includes classifying the implicit premise by determining a dialogue pattern and tracking a flow of information during the dialogue.

11. The method of claim 1, wherein the generative model is configured to understand conversational contexts and flows information to determine the intent of each source of the plurality of sources.

12. The method of claim 1, further comprising:
providing, via the user interface, the intent of the preferred source.

13. The method of claim 1, receiving the preferred source, via the user interface, with the conversation data.

14. The method of claim 1, wherein the plurality of sources include a human speaker or information provided via artificial intelligence.

15. A non-transitory computer-readable medium storing executable instructions that when executed by an electronic processor, cause the electronic processor to:
receive, via a user interface, conversation data regarding a conversation among a plurality of sources;
process the conversation data through a generative model to associate an intent to each source of the plurality of sources, and
provide, via the user interface, a summary for the conversation based on a preferred source of the plurality of sources and the intents associated with each source of the plurality of sources.

16. The non-transitory computer-readable medium of claim 15, wherein the generative model is configured to generate the summary for the conversation based on a weighted value associated with each source of the plurality of sources.

17. The non-transitory computer-readable medium of claim 16, wherein the conversation includes a plurality of dialogues, and wherein each dialogue of the plurality of dialogues is associated with a source of the plurality of sources, and wherein the generative model is configured to track a semantic meaning of each dialogue of the plurality of dialogues and relabel the source according to each respective intent.

18. A system comprising:
an electronic processor; and
a memory communicably coupled to the electronic processor and storing instructions that, when executed by the electronic processor, cause the system to:
receive, via a user interface, conversation data regarding a conversation among a plurality of sources;
process the conversation data through a generative model to associate an intent to each source of the plurality of sources, and
provide, via the user interface, a summary for the conversation based on a preferred source of the plurality of sources and the intents associated with each source of the plurality of sources.

19. The system of claim 18, wherein the generative model associates the intent to each source of the plurality of sources by:
determining explicit words in a dialogue provided by the source;
determining an implicit premise of the source during the dialogue; and
determining the intent for the source based on the explicit words and the implicit premise.

20. The system of claim 19, wherein determining the implicit premise for the source includes classifying the implicit premise by determining a dialogue pattern and tracking a flow of information during the dialogue.
